(19) United States
(12) Patent Application Publication
(10) Pub. No.: US 2026/0264375 A1
(43) Pub. Date: Sep. 10, 2026

(54) SHEET CONTAINING A THERMOPLASTIC ELASTOMER, PREPARATION METHOD AND USE

(71) Applicants: TMG - TECIDOS PLASTIFICADOS E OUTROS REVESTIMENTOS PARA A INDÚSTRIA AUTOMÓVEL, S.A., SÃO COSME DO VALE (PT); The Haartz Corporation, Acton, MA (US)

(72) Inventors: Gonçalo CAMPOS DE ARAÚJO MESQUITA DA SILVEIRA, São Cosme Vale (PT); Helena Isabel PEREIRA DA COSTA AGUILAR RIBEIRO, São Cosme Vale (PT); Ivone Marisa DA SILVA MAIA, São Cosme Vale (PT); João Nuno FERREIRA DA MOTA, São Cosme Vale (PT); José António RIBEIRO FERREIRA, São Cosme Vale (PT); Mark G. HELDER, Acton, MA (US); Pedro José ERREIRA FERNANDES, São Cosme Vale (PT); Sara Patricia DA SILVA MARQUES, São Cosme Vale (PT); Srinivas P. SITARAM, Acton, MA (US); Walter E. ROBAR, Acton, MA (US)

(73) Assignees: TMG - TECIDOS PLASTIFICADOS E OUTROS REVESTIMENTOS PARA A INDÚSTRIA AUTOMÓVEL, S.A., SÃO COSME DO VALE (PT); The Haartz Corporation, Acton, MA (US)

(21) Appl. No.: 18/869,386

(22) PCT Filed: Nov. 10, 2022
(86) PCT No.: PCT/EP2022/081532

§ 371 Date: Nov. 26, 2024

(30) Foreign Application Priority Data
Jun. 3, 2022 (PT) 118029

(51) Int. Cl. B32B 25/10; B32B 3/30; B32B 5/26; B32B 7/12

(52) U.S. Cl. CPC B32B 25/10; B32B 3/30; B32B 5/26; B32B 7/12; B32B 2307/7376; B32B 2605/003

(57) ABSTRACT

A sheet comprising a support layer made of a textile, a cover layer on the support layer, and a compound structure, wherein the cover layer contains a thermoplastic elastomer, and wherein the compound structure consists of a part of the support layer and a part of the cover layer interpenetrating each other, wherein the extent of interpenetration, defined as [(thickness of the compound structure)/(thickness of the cover layer)]×100%, is 5% to 99 %; a method of preparing the sheet; and the use of the sheet as a surface material in the interior of a vehicle.

### FIELD OF THE INVENTION

The present invention relates to a sheet comprising a support layer, a cover layer and a compound structure, a method of preparing the sheet, and the use of the sheet as a surface material such as an artificial leather for trim in a vehicle.

### BACKGROUND ART

EP 3 766 687 A1 discloses a composite structure containing a low-density foam layer and an inner layer and an outer layer of a thermoplastic compact cover layer. The composite structure soft and flexible and shows good properties as airbag cover such as a low tensile strength.

EP 3 533 601 A1 discloses a composite structure comprising a low-density foam layer, a textile layer, and a thermoplastic cover layer comprising two sublayers. The composite structure shows good tearing properties and haptics and is improved in terms of wrinkle formation and handling during processing, especially during sewing. The composite structure is prepared by hot melt lamination.

EP 3 960 440 A1 discloses a composite structure comprising a textile layer arranged between a cover layer and an underlayer, wherein the cover layer and the underlayer fully penetrate the textile layer and are thermally bonded to each other.

### Problem to be Solved by the Invention

The state of the art discloses composite structures having several layers to provide the desired balance of, on the one hand, properties in terms of softness and flexibility to achieve good haptics and handling during processing such as sewing and, on the other hand, a facilitated production of the composite structure.

The problem underlying the present invention was to provide a new structure achieving the desired balance of properties with fewer layers than the prior art structures and by using an improved preparation method.

### SUMMARY OF THE INVENTION

The problem underlying the present invention was solved by providing the sheet according to the present invention.

The present application covers the following preferred aspects.
[1] A sheet comprising a support layer, a cover layer and a compound structure, wherein the support layer contains a textile layer, the cover layer is a compact layer containing a thermoplastic elastomer and is arranged on the textile layer of the support layer, and the compound structure consists of a part of the support layer and a part of the cover layer interpenetrating each other, wherein the extent of interpenetration, defined as [(thickness of the compound structure)/(thickness of the cover layer)]×100%, is 5% to 99%, the thickness of the cover layer being the thickness of the compound structure plus the thickness of the part of the cover layer not being part of the compound structure.
[1-1] The sheet according to aspect [1], which is suitable for preparing a sewn product obtainable by sewing at least two layers of the sheet, preferably for preparing a sewn product by folding the sheet, placing the support layers together and sewing the two parts of the sheet in the contact area.
[1-2] The sheet according to any of the preceding aspects, wherein the part of the support layer being part of the compound structure has at least 80% of the area density of the support layer not being part of the compound structure, as observed by microscopy of a cross-section of the sheet.
[1-3] The sheet according to any of the preceding aspects, wherein the cover layer consists of a single composition, preferably in a single layer.
[1-4] The sheet according to any of the preceding aspects, wherein the cover layer comprises two or more layers, wherein the compositions of the layers preferably differ from each other.
[1-5] The sheet according to any of the preceding aspects, wherein the extent of textile layer interpenetration, defined as [(thickness of the compound structure)/(thickness of the textile layer)]×100%, is 10% to 90%, the thickness of the textile layer being the thickness of the compound structure plus the thickness of the part of the textile layer not being part of the compound structure.
[1-6] The sheet according to a combination of aspects [1] and [1-5].
[1-7] The sheet according to any of the preceding aspects, wherein the cover layer has a light transmittance of 1% to 100%, preferably 1% to 50%, more preferably 5% to 50%.
[1-8] The sheet according to any of the preceding aspects, wherein the support layer, particularly the textile layer, has a light transmittance of 1% to 100%, preferably 1% to 50%, more preferably 5% to 50%. [1-9] The sheet according to any of the preceding aspects, wherein the compound structure has a light transmittance of 1% to 100%, preferably 1% to 50%, more preferably 5% to 50
[1-10] The sheet according to any of the preceding aspects, which has a light transmittance of 1% to 100%, preferably 1% to 50%, more preferably 5% to 50%.
[1-11] The sheet according to a combination of aspects [1-6] and [1-7].
[1-12] The sheet according to a combination of aspects [1-6] and [1-10].
[1-13] The sheet according to any of the preceding aspects, wherein the support layer is a textile layer and a foam layer, preferably a polyolefin foam layer, is bonded either directly or via an adhesive layer to the underside of the textile layer.
[2] The sheet according to any of the preceding aspects, wherein the extent of cover layer interpenetration and/or textile layer interpenetration is 10% to 70%, preferably 15% to 60
[3] The sheet according to any of the preceding aspects, wherein the content of the thermoplastic elastomer in the cover layer composition is at least 50%.
[4] The sheet according to any of the preceding aspects, wherein the cover layer composition has a Shore A hardness according to DIN 53505 of less than 90, preferably less than 70, even more preferably less than 50.
[4-1] The sheet according to any of the preceding aspects, having a Shore A hardness according to DIN 53505 of 20 to 50.
[4-2] The sheet according to a combination of aspects [4] and [4-1].
[5] The sheet according to any of the preceding aspects, wherein the part of the cover layer not being part of the compound structure has a thickness of at least 0.04 mm, preferably at least 0.2 mm.
[6] The sheet according to any of the preceding aspects, wherein the support layer contains textile layer having a thickness of 0.3 to 5 mm; the cover layer has a thickness of 0.1 mm to 1.5 mm; and the compound structure has a thickness of 0.01 to 1.0 mm.
[6-1] The sheet according to aspect [6], wherein the thickness of the textile layer of the support layer is at least two times the thickness of the cover layer.
[6-2] The sheet according to any of the preceding aspects, wherein the cover layer has a thickness of 0.1 mm to 1.5 mm and the compound structure has a thickness of 0.01 mm to 1.0 mm.
[6-3] The sheet according to aspect [6-2], wherein the part of the cover layer not being part of the compound structure has a thickness of at least 0.04 mm, the extent of interpenetration is 10 to 70%, and the thickness of the support layer, preferably the textile layer of the support layer, is at least two times the thickness of the cover layer.
[7] The sheet according to any of the preceding aspects, wherein the support layer comprises a textile layer having a thickness of 0.3 to 5.0 mm, a foam layer having a thickness of 0.5 to 10 mm and, optionally, a textile layer having a thickness of 0.3 to 2.5 mm in this order, wherein each of the textile layers is preferably directly bonded to the foam layer; or wherein the support layer comprises two textile layers bonded to each other by an adhesive layer.
[8] The sheet according to any of the preceding aspects, wherein the textile layer of the support layer contains or consists of one or more kinds of fibers selected from the group consisting of polyester, polypropylene, polyamide, cotton or other natural fibers.
[8-1] The sheet according to aspect [8], wherein the fibers are polypropylene fibers and the cover layer is based on polypropylene.
[8-2] The sheet according to a combination of aspects [7] and [8-1], wherein the textile layer consists of polypropylene fibers.
[9] The sheet according to any of the preceding aspects, wherein the sheet is obtainable by a process comprising thermally or thermo-mechanically bonding the cover layer and the support layer.
[9-1] The sheet according to aspect [9], wherein the compound structure is formed in a bonding step, in which the cover layer composition or at least a part of a film made of the cover layer composition is in molten form and the support layer is in non-molten form, or wherein the cover layer composition or at least a part of a film made of the cover layer composition is in molten form and at least a part of the support layer is in molten form.
[9-2] The sheet according to aspect [9] or [9-1], wherein the process of bonding the cover layer and the support layer comprises applying pressure and thermal treatment in a single step.
[10] The sheet according to any of the preceding aspects, wherein the sheet has a tear propagation force according to DIN EN ISO 4674-1 of 10 to 50 N in longitudinal direction and in transverse direction.
[11] The sheet according to any of the preceding aspects, wherein the sheet is an artificial leather.
[11-1]A sewn product obtainable by sewing at least two layers of the sheet according to any of the preceding aspects.
[12] The use of a sheet as described in any of aspects [1] to [11] or the sewn product described in aspect [11-1] as a surface material in the interior of a vehicle, preferably for a cut & sew process.
[13]A method of preparing a sheet as described in any of aspects [1] to [11], comprising the following steps:
(a) providing a cover layer composition containing a thermoplastic elastomer;
(b) at least partly melting the thermoplastic elastomer of the cover layer composition;
(c) forming a laminate of the cover layer composition containing the at least partly molten thermoplastic elastomer and a support layer containing a textile layer such that the cover layer composition and the textile layer of support layer at least partly interpenetrate each other; and
(d) cooling the cover layer composition to obtain the sheet.
[13-1] The method of aspect [13], wherein a step of embossing the sheet to form a grained structure on the cover layer is carried out before, after, or at the same time as the step of forming the laminate.
[14] The method of aspect [13], wherein the melting in step (b) and the laminate forming in step (c) is carried out using an extruder.
[15] The method of aspect [13], wherein step (a) comprises providing the cover layer composition in the form of a film made of the cover layer composition, step (b) comprises heating the film at least on one side to at least partly melt the thermoplastic elastomer, and step (c) comprises step (c1) of forming a laminate by contacting the one side of the film and the support layer and step (c2) of forming a grained structure by embossing the other side of the film, wherein steps (c1) and (c2) are carried out simultaneously, preferably by using cylinders.

### Advantages of the Invention

The sheet according to the invention exhibits a low wrinkle formation when bent. This makes it easier to handle and, in particular, facilitates sewing. The manufacturing costs can be reduced by reducing the number of layers and by using a facilitated production in a one-step lamination process. A further advantage is the easy recyclability of the sheet when the material of the layers is selected from the same compound family.

### DESCRIPTION OF THE DRAWINGS

FIG. 1 shows a cross-section of the sheet of Example 1. The extent of interpenetration is 22%.

FIG. 2 shows a cross-section of the sheet of Example 2. The extent of interpenetration is 29%.

FIG. 3 shows a cross-section of the sheet of Example 3. The extent of interpenetration is 37%.

FIG. 4 shows a cross-section of the sheet of Comparative Example 1. The extent of interpenetration is 0%.

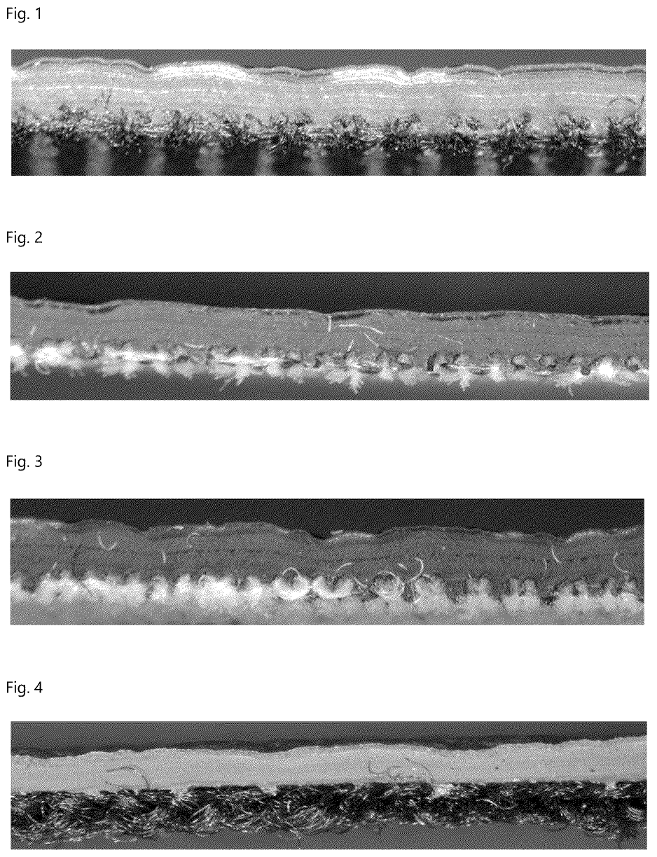

### EMBODIMENTS OF THE INVENTION

In the present invention, the terms “comprises,” “comprising,” “including,” and “having,” are inclusive and therefore specify the presence of stated features, steps, and/or components, but do not preclude the presence or addition of one or more other features, steps, components, and/or groups thereof. The method steps, processes, and operations described herein are not to be construed as necessarily requiring their performance in the particular order discussed or illustrated, unless specifically identified as an order of performance. It is also to be understood that additional steps may be employed.

Whenever it is mentioned in the context of this description that individual compositions or layers are based on or made of a certain material, this should be interpreted as the respective material forming the main constituent of the composition or layer, wherein other constituents may also be present in small quantities. In embodiments, the terms “based on” or “made of” a certain material means a content of more than 50%, preferably 90%, and more preferably 95%.

As used herein, the singular forms “a,” “an,” and “the” may be intended to include the plural forms as well, unless the context clearly indicates otherwise. For instance, structural elements and components are generally described in the singular form, e.g. “a” component or “containing a” component. Such singular form formulations are meant to include more than one of the indicated component or structural element, unless indicated otherwise.

The term “and/or” includes any and all combinations of one or more of the associated listed items. Percentages (%) of contents of components are percentages by mass (% by mass) unless explicitly indicated otherwise. The standards and norms mentioned refer to the latest version available at the time this application was filed, unless indicated otherwise.

### Sheet

The sheet according to the present invention comprises a support layer, a cover layer and a compound structure as mandatory components. The cover layer may optionally be coated with a lacquer layer. The sheet is a layer structure itself. The plane of the sheet layer is sometimes referred to as “the layer plane”.

In the sheet of the present invention, the compound structure consists of a part of the support layer and a part of the cover layer. In each case, the term “a part” means that the respective layer is not included in the compound structure over the whole thickness direction of the respective layer. In other words, a full interpenetration is excluded, and both the cover layer and the support layer have an un-interpenetrated layer part in the thickness direction. As a result, the textile layer is not exposed at the topside (i.e., the cover layer surface) of the sheet, and the cover layer is not exposed at the underside (i.e., the textile layer surface) of the sheet.

Preferably, the sheet is suitable for preparing a sewn product obtainable by sewing at least two layers of the sheet. The sewn product may be prepared by folding the sheet, placing the support layers together and sewing the two parts of the sheet in the contact area. In order for the sheet according to the invention to have the desired properties, e.g. easy processability when sewing, the sheet must not be too hard. The Shore A hardness of the sheet according to the invention is therefore preferably less than 90 and more preferably less than 50. For suitability for sewing, it is also important that the sheet has a suitable stitch tear-out force. This is preferably at least 40 N according to DIN EN ISO 23910.

In one embodiment, the sheet is both suitable as a tearable coating for an airbag cover without a material weakening and suitable for preparing a sewn product obtainable by sewing at least two layers of the sheet.

In one embodiment, the sheet is formed exclusively by thermal bonding, i.e. by using a molten cover layer composition or at least partly molten cover layer. Preferably, the textile layer of the support layer is not melted at the temperature used in the thermal bonding. For instance, polypropylene fibers in the support layer may partly melt and be thermally bonded. On the other hand, polyester fibers may not melt and may be bonded to the cover layer by thermo-mechanical bonding, i.e., solely be penetration of the molten cover layer material into the textile layer. In the case of a connection of the support layer and the cover layer exclusively by thermal bonding, the connection is reversible, and support layer and the cover layer can be separated from each other at room temperature or by heating to melt at least the part of the cover layer that is part of the compound structure. In another embodiment, the connection of the support layer and the cover layer is enforced by treating the sheet e.g. with irradiation or electron beams to from the downside of the support layer to form chemical bonds between within the compound structure. In that case, the connection between the support layer and the cover layer is not reversible, i.e. the layers cannot be separated by at least partly melting the cover layer.

The support layer and the cover layer of the sheet may be characterized by their thickness. In the present invention, the thickness of the cover layer is defined as the thickness of the compound structure plus the thickness of the part of the cover layer not being part of the compound structure. Similarly, the thickness of the support layer is defined as the thickness of the compound structure plus the thickness of the part of the support layer not being part of the compound structure. As a result, the thickness of the sheet may be the total of the thickness of the raw material support layer and the thickness of the raw material cover layer minus the thickness of the compound structure. In the present invention, the thickness of a layer or structure in the sheet may be determined by preparing a cross-section perpendicular to the layer plane of the sheet and observing the cross-section using a microscope. The thickness of the layer or structure is the average thickness obtained by determining the thicknesses within a range of at least 10 mm of the length of said layer or structure.

The sheet according to the present invention may be opaque or translucent. Generally, a translucent structure allows the transmittance of more visible light than an opaque structure when light is emitted from the same light source and hits the structures.

In the present invention, the meaning of the term “translucency” covers the meaning of “transparency”. In general, transparency is the physical property of allowing light to pass through the material without being scattered. Translucency is a superset of transparency and allows light to pass through and allows scattering. In other words, a translucent medium allows the transport of light while a transparent medium not only allows the transport of light but allows for image formation. Transparent materials appear clear. Since the value of the light transmittance is affected by absorption, scattering, reflection and the like, the exact light transmittance values of the different components of the composite structure may vary depending on the type of light source, the composition and thickness of the various layers. The light transmittance also differs for different wavelength ranges.

The light transmittance of the layer structures described in the present application, i.e., the individual layers or any of the composite structures, respectively, is determined as follows: Equipment: Datacolor, model 850; Lamp: Xenon. The total transmittance is measured according to the user's guide provided by the manufacturer. A white plaque (e.g. Spectralon® plaque) is used as an optical standard for transmission calibration and measurement. The white plaque is placed at the front aperture plate. The sample to be measured is placed between the sphere opening and the sensor. The transmittance is determined within the range of 400 to 700 nm at the wavelength λₘₐₓ of the maximum transmittance peak for the sample. The light transmittance [%] of a sample is defined as 100%×(transmittance value measured at λₘₐₓ in the presence of the layer structure)/(transmittance value measured at λₘₐₓ in the absence of the layer structure). The light transmission means the permeability for light emitted at a position facing the underside of the sheet or layer and detected at a position facing the topside of the sheet or layer. The light transmittance of the sheet refers to the whole sheet if all layers are translucent.

The light transmittance of the sheet may be 1% to 100%, 1% to 90%, 1% to 50%, or 5 to 50%, preferably 1% to 30%, more preferably 2 to 20%. A low light transmittance such as 1% to 50% may be advantageous for hidden-until-lit applications.

### Support Layer

The support layer contains a textile layer. Preferably the support layer consists of a textile layer. Examples of a textile layer are knitted fabrics, woven textiles, non-woven textiles, glass fiber textiles, spunlace, or a spacer fabric. A knitted fabric is a flexible material made by creating an interlocking bundle of yarns or threads, which are produced by spinning raw fibers into long and twisted lengths. A spacer fabric is a flexible material formed of two surface textile layers held by spacer threads in a defined spacing. A textile or a fabric is not compact and comprises a large volume ratio of hollow spaces that are usually filled with air. The density of the textile layer is preferably 100 to 300 kg/m³.

The textile layer of the support layer may contain or consist of one or more kinds of fibers selected from the group consisting of polyester, polypropylene, polyamide, cotton and natural fibers. Preferably, the textile layer consists of polypropylene fibers. In a preferred embodiment, the fibers are polypropylene fibers and the cover layer is based on polypropylene. Hence, the sheet may be made of a monomaterial.

The support layer may consist of a single layer, i.e. the textile layer forming the compound structure with the cover layer. Since the cover layer may also consist of a single layer, the sheet may consist of only two layers, i.e., the support layer and the cover layer, and an optional lacquer layer.

The support layer may contain other layers in addition to the textile layer. For instance, the support layer may comprise a textile layer having a thickness of 0.3 to 5 mm, a foam layer described below having a thickness of 0.5 to 10 mm and, optionally, a textile layer having a thickness of 0.3 to 2.5 mm in this order, wherein each of the textile layers is preferably directly bonded to the foam layer. The direct bonding excludes an additional layer or adhesive layer between the textile layer and foam layer. Hence, the sheet may contain several layers without containing any adhesive layer. The foam layer may have adhesive properties so that it can adhere firmly to a topside or underside textile or fabric layer without the addition of another adhesive.

In embodiments, an adhesive layer may be arranged between the textile layer and the foam layer and/or between the foam layer and the optional textile layer. If the support layer contains two adjacent textile layers, they may be bonded to each other by an adhesive layer. The adhesive may be a polyolefinic adhesive, a polyurethane adhesive, an acrylic adhesive, or a hot melt adhesive based on polyurethane (PUR). The adhesive may be used in a thickness of 40 μm. The support layer may contain a textile layer, an adhesive layer, a foam layer, an adhesive layer, and a textile layer in this order.

The composition of the optional foam layer is not restricted. The foam layer may consist of or contain PVC foam, TPE based foams, PUR based foams and/or EVA/EMA foams. Preferably, the foam layer consists of or contains polyolefin foam. The thermoplastic polyolefins (TPO) described herein in relation to the cover layer can also be used for the foam layer. The foam layer consists of or contains polypropylene foam (PP foam) in a preferred embodiment. Polypropylene (PP) is understood here to be such polymers or copolymers whose weight proportion of propylene is >50%. The foam layer may contain common additives, such as lubricants, stabilizers, fillers, such as inorganic fillers, and/or pigment. The foam may be produced by first sheet extrusion, followed by crosslinking and then expansion.

The foam layer may have a thickness of 0.5 to 10 mm. Preferably, the thickness of the foam layer is 1.0 to 5.0 mm. The density of the foam layer is preferably in the range from 30 to 300 kg/m³, more preferably 30 to 150 kg/m³ and even more preferably 40 to 100 kg/m³. The higher the density of the foam, the higher is its strength. The gel content mentioned herein is measured according to ASTM D2765-16. A sample is weighed (initial weight) and placed in xylene for 24 hours at 180° C., the dissolved material is separated and the weight of the remaining material is determined (final weight); gel content [%][(final weight)/(initial weight)]×100%.

The support layer may be an opaque layer or a translucent layer. In particular, the textile layer may be an opaque layer or a translucent layer. The light transmittance of the support layer may be 1% to 100%, 1% to 90%, 1% to 50%, or 5 to 50%, preferably 1% to 30%, more preferably 2 to 20%.

### Cover Layer

The cover layer has a density of preferably at least 800 kg/m³, more preferably higher than 850 kg/m³. Preferably, the cover layer is compact. The cover layer may consist of one or more layers. Preferably, the cover layer consists of a single layer.

The cover layer is thermoplastic. This property requires that the overall degree of crosslinking is not too high. The gel content is preferably less than 20%, more preferably less than 15%. The gel content may be 0 to 50%.

The melting point and the Shore A hardness of the cover layer are mainly determined by the properties of the thermoplastic elastomer. The thermoplastic elastomer used in the cover layer may or may not have a melting temperature. In the former case, the melting temperature is preferably in the range of 100 to 180° C., more preferably 110 to 170° C. Accordingly, the melting point of the cover layer composition is preferably in the range of 100 to 180° C., more preferably 110 to 170° C.

The cover layer may contain usual additives such as plasticizers, stabilizers, anti-aging agent (e.g. antioxidants), fillers and pigments (silica, TiO₂, CaCO₃, Mg(OH)₂, carbon black, mica, kaolin, clay, coal dust, lignin, talc, BaSO₄, Al(OH)₃, ZnO, and MgO), flame retardants (e.g. antimony trioxide or zinc hydroxystannate), waxes, colorants, compatibilizers and other auxiliary substances (e.g. viscosity aids, adhesion promoters, etc.). An example of an additive is a UV stabiliser which may be selected from one or more members of the group consisting of benzotriazole or hindered amine light stabilizers.

The cover layer of the sheet preferably has a grain, i.e. a three-dimensionally structured surface on the top side covered with lacquer. The grain may be present in the cover layer only or both in the cover layer and the lacquer layer. In that case the sheet structure may be used as an artificial leather. The grain may be introduced by known methods such as embossing or using a release paper having a surface showing a negative of the structure of the desired grain. The depth of the grain is less than the thickness of the cover layer and is preferably 10 to 500 μm, more preferably 50 to 500 μm, still more preferably 50 to 300 μm. The grain can be produced using conventional methods. The grain can be produced as a paper grain. For this purpose, the starting material is coated onto a structured carrier material, e.g. a release paper. Afterwards, the carrier paper is removed and the surface lacquering is applied in several steps by means of gravure printing. Alternatively, the graining or embossing is preferably applied to the artificial leather surface by means of an embossing roller while applying pressure and temperature after the lacquering.

The cover layer contains a thermoplastic elastomer (TPE). A thermoplastic elastomer is defined as an elastomer showing thermoplastic behaviour. The term “thermoplastic” denotes polymers or polymer compositions that show thermoplastic properties, in particular thermoreversibility. TPE behaves rubber-elastically in the range of usual service temperatures. TPE is a copolymer or an elastomer alloy, i.e., a physical mix of polymers that consists of materials with both thermoplastic and elastomeric properties. Copolymers are statistical copolymers or block copolymers, which consist of a main polymer such as polyethylene, whose degree of crystallization is reduced to a certain extent by a randomly incorporated comonomer such as vinyl acetate. In block copolymers, the hard and soft segments in a molecule are sharply separated (e.g. SBS, SIS). Copolymers can therefore consist of a soft elastomer and a hard thermoplastic component. Elastomer alloys are blends of finished polymers. The desired properties can be obtained by varying the mixing ratios.

Generally, there are the following generic classes of TPEs (designations according to ISO 18064): Styrenic block copolymer (TPS), thermoplastic polyolefin elastomer (TPO), thermoplastic vulcanizate (TPV), thermoplastic polyurethane (TPU), thermoplastic copolyester (TPC), melt processing rubbers, and thermoplastic polyamide (TPA).

The TPE used in the present invention may belong to one generic class or may be a blend of TPEs from two or more classes. Also, the TPE may be selected from one class and may be one kind of TPE of one class or a blend of two or more kinds of TPEs of one class. The content of TPE in the cover layer is preferably at least 50%. The total content of thermoplastic polymers, i.e., TPE and other thermoplastic polymers, in the cover layer is preferably at least 80%, more preferably at least 90%. Preferably, the total content of polymers in the cover layer consists of TPE and other thermoplastic polymers. More preferably, the total content of polymers in the cover layer consists of thermoplastic polymers, i.e., TPE and other thermoplastic polymers such as TPO, and is at least 80%, most preferably at least 90%.

Common elastomers include ethylene propylene rubber (EPR), EPDM (ethylene-propylene-diene rubber), ethylene-octene (EO), ethylbenzene (EB), and styrene ethylene butadiene styrene (SEBS). Thermoplastic polyurethane (TPU) is a thermoplastic elastomer consisting of linear segmented block copolymers composed of hard and soft segments.

In the present invention, the terms “elastomer” and “rubber” are used synonymously. They denote polymers that show elastic properties and are crosslinked. They may or may not have a gel content. Their gel content may be between 1% and 50%, preferably between 2% and 50%, more preferably between 5% and 50%.

The rubber may be selected from the group consisting of natural rubber (NR), nitrile butadiene rubber (NBR), hydrogenated nitrile butadiene rubber (HNBR), carboxylated nitrile rubber (XNBR), butyl rubber (IIR), chlorobutyl rubber (CIIR), bromobutyl rubber (BIIR), polychloroprene (CR), styrene-butadiene rubber (SBR), polybutadiene (BR), ethylene-propylene-diene tripolymer (EPDM), ethylene-propylene rubber (EPR or EPM), silicone rubber, acrylic rubber (ACM), ethylene-vinylacetate copolymer rubber (EVM), polyurethane rubber (PU), and any combination of the above. The rubber can also be a styrene based thermoplastic elastomer (STPE). In particular, the rubber may be selected from the group comprising ethylene/α-olefin copolymer rubber (EAM) as well as ethylene/α-olefin/diene terpolymer rubber (EADM). Preferably the diene in the ethylene-α-olefin-diene rubber is preferably a nonconjugated diene. Suitable non-conjugated dienes include dicyclopentadiene, alkyldicyclopentadiene, 1,4-pentadiene, 1,4-hexadiene, 1,5-hexadiene, 1,4-heptadiene, 2-methyl-1,5-hexadiene, cyclooctadiene, 1,4-octadiene, 1,7-octadiene, 5-ethylidene-2-norbornene, 5-n-propylidene-2-norbornene, and 5-(2-methyl-2-butenyl)-2-norbornene. In preferred embodiments, the rubber component comprises an ethylene-α-olefin-diene rubber. The ethylene-α-olefin-diene rubber may comprise an α-olefin having 3 to 8 carbon atoms. The α-olefin in an EAM or EADM rubber is preferably propylene; in such a case the rubber is referred to as EP(D)M. Here, EPM may also be referred to as EPR. It is also possible to use a mixture of the rubbers mentioned above.

In a preferred embodiment of the present invention, the rubber consists of EPDM and EPR. In that case, EPDM preferably constitutes at least 80% of the total rubber content in the cover layer. It is preferred that EPDM is contained in a TPV raw material and EPR is contained in a TPO raw material.

EPDM is made from ethylene, propylene and a diene comonomer that enables crosslinking via sulphur vulcanization systems. EPDM contains crosslinks and is preferably fully cured, i.e. crosslinked to an extent of at least 98%, most preferably to an extent of 100%. The content of propylene is preferably 45% to 85%. Preferred dienes used in the manufacture of EPDM rubbers are ethylidene norbornene (ENB), dicyclopentadiene (DCPD), and vinyl norbornene (VNB). EPDM is preferably crosslinked via vulcanization with sulphur or by using peroxides. Propylene reduces the formation of the typical polyethylene crystallinity. EPDM is a semi-crystalline material with ethylene-type crystal structures at higher ethylene contents, becoming essentially amorphous at ethylene contents that approach 50%. EPDM may be compounded with fillers such as carbon black and calcium carbonate, and with plasticizers such as paraffinic oils.

EPR (also referred to as “EPM”) is a random copolymer of ethylene and propylene. EPR is similar to EPDM but contains no diene units. It is crosslinked using radical methods such as peroxides. EPR of different properties can be obtained by varying the monomer ratios. These properties are e.g. viscosity or crystallinity. EPR having from amorphous to semi-crystalline structure can be obtained. EPR preferably comprises 40 to 80%, more preferably 40 to 60% of ethylene units. EPR copolymers containing less than about 40% ethylene generally are known to have poor elasticity at low temperatures, and thus may provide compositions that are too rigid and lack the balance of mechanical properties over a wide temperature range needed for most automotive applications. At high levels of ethylene, generally above about 60% ethylene units, separate crystalline ethylene domains may form within the rubber component, and interphase adhesion and miscibility are reduced. EPR may be contained in a thermoplastic resin composition in an amount of 10 to 60%, preferably 15 to 40%. Resins with less than 10% of EPR are more rigid and less flexible. The presence of the rubber component at high levels above about 60% decrease stiffness and tensile strength.

The rubber component contained in the sheet according to the present invention is preferably contained in a thermoplastic vulcanizate (TPV), which can be used as a raw material for producing the cover layer. TPV as one class of TPE combines the characteristics of vulcanized rubber with the processing properties of thermoplastics. TPV contains rubber particles cured by vulcanization. The rubber particles encapsulated in a thermoplastic matrix.

In the present invention, the rubber particles are made of the rubber described herein, and the thermoplastic matrix is made of TPO described herein. The resin components of TPV may consist of 10-90 parts by weight of the polyolefin resin and correspondingly 90-10 parts by weight of the rubber, preferably 10-80/80-20 parts by weight, and more preferably 30-70/70-30 parts by weight. In the present invention, a TPV based on polypropylene (PP) and EPDM rubber is preferred.

The TPV can either be prepared by mixing the polyolefin with a particulate form of the vulcanized rubber or via a process known as dynamic vulcanization. Dynamic vulcanization consists of intimately mixing a blend of compatible polymers, then introducing a crosslinking system in the mixture while the mixing process is continued. The mechanical performance of TPV improves with the degree of crosslinking of the rubbery phase and with the inverse of the particle size of rubbery domains. TPV can be processed using conventional thermoplastic processes such as injection molding, blow molding and extrusion.

TPV may be compounded with additives. In particular, the TPV may contain different ingredients such as reinforcing fillers (carbon black, mineral fillers), stabilizers, plasticizing oils, and curing systems.

The thermoplastic elastomer may have the shape of particles. The particles are preferably embedded in a matrix of the other polymers present in the layer. The particle size is preferably below 10 μm, more preferably below 1 μm. Preferably, at least 90% of the particles have a size of less than 10 μm. The size can be determined by scanning electron microscopy (SEM) of a cross section of the layer. The longest diameter of a particle image in an SEM micrograph is defined as its size.

In addition to the thermoplastic elastomer, the cover layer may contain thermoplastic polymers, in particular, thermoplastic polyolefin (TPO). The degree of crosslinking in thermoplastic polyolefins is low. Their gel content is preferably less than 5%, more preferably less than 2%. TPO is a polymer produced from alkenes such as ethylene, propylene, 1-butene or isobutene by chain polymerization. It is a semi-crystalline thermoplastic polymer that is easy to process. Examples of TPO are polyethylene (PE), polypropylene (PP), polymethylpentene (PMP), polyisobutylene (PIB) and polybutylene (PB, polybutene-1). Polyethylene (PE) is defined here as polymers or copolymers whose proportion by weight of ethylene is more than 50%. Polypropylene (PP) is defined here as polymers or copolymers whose proportion by weight of propylene is more than 50%. Examples of TPO are blends of polyethylene (PE) and polypropylene (PP). Examples of PE are HDPE, LDPE and LLDPE. HDPE has weakly branched polymer chains and therefore has a high density between 0.94 g/cm³ and 0.97 g/cm³. LDPE and LLDPE are described below. The properties of TPO can be influenced by the addition of elastomers or other substances such as talcum.

Examples of blends of rubber with TPO are ethylene propylene diene rubber (EPDM) with polyethylene (PE) and/or polypropylene (PP), blends of ethylene propylene rubber (EPM) with polypropylene (PP) and/or polyethylene (PE) and ethylene propylene blends, and blends of styrene ethylene butadiene styrene (SEBS) with TPO such as polyethylene (PE) and/or polypropylene (PP). A composition may contain elastomers such as EPR or EPDM or SEBS to such an extent and having such a degree of crosslinking that the composition is still thermoplastic.

The cover layer may be an opaque layer or a translucent layer. The light transmittance of the cover layer may be 1% to 100%, 1% to 90%, 1% to 50%, or 5 to 50%, preferably 1% to 30%, more preferably 2 to 20%.

### Compound Structure

The sheet contains a compound structure. The compound structure as such is not a layer.

The compound structure is defined by the interaction between the support layer and the cover layer. Preferably, this interaction is exclusively a physical interaction and excludes chemical interactions such as chemical bonds. The compound structure consists of a part of the support layer and a part of the cover layer interpenetrating each other. The extent of cover layer interpenetration is 5% to 99%, preferably 10% to 70%, more preferably 15% to 60%, and is defined as follows: Extent of interpenetration [%]=[(thickness of the compound structure)/(thickness of the cover layer)]×100%. The thickness of the cover layer is defined as the thickness of the compound structure plus the thickness of the part of the cover layer not being part of the compound structure. Similarly, the extent of textile layer interpenetration is 10% to 90%, preferably 10% to 70%, more preferably 15% to 60%, and is defined as follows: Extent of interpenetration [%]=[(thickness of the compound structure)/(thickness of the textile layer)]×100%. The thickness of the textile layer is defined as the thickness of the compound structure plus the thickness of the part of the textile layer not being part of the compound structure.

The extent of interpenetration as defined above is limited. The limitation has the advantage that the support layer structures are not be visible at the topside of the cover layer and do not affect the appearance of the sheet. The extent of interpenetration of the cover layer into the textile layer of the support layer is also limited, which maintains the sheet flexible. The ratio of the support layer, which is not part of the compound structure in the thickness direction, is preferably at least 10%, more preferably at least 20%, and most preferably at least 50%. In one embodiment, the extent of interpenetration, defined as [(thickness of the compound structure)/(thickness of the textile layer)]×100%, is 10% to 90%, preferably 10% to 70%, the thickness of the textile layer being the thickness of the compound structure plus the thickness of the part of the textile layer not being part of the compound structure.

The compound structure may be characterized by the structure of a cross-section of the sheet perpendicular to the layer plane, as observed with a microscope. In one embodiment, the reaction conditions, e.g., the pressure and the temperature, may be adjusted such that the density of the support layer is only slightly reduced in the lamination step. In one embodiment, the part of support layer being part of the compound structure has at least 80% of the area density of the support layer not being part of the compound structure. The density of the textile layer may be adjusted such that the compound structure is composed of similar ratios of support layer and cover layer. As observed by microscopy of a cross-section of the sheet perpendicular to the layer plane, the compound structure may consist of 30 to 70% of the support layer material and 70 to 30% of the cover layer material. The process of lamination may be adjusted such that the hollow spaces (which are usually filled with gas such as air) in the textile layer of the support layer are (almost) completely filled with cover layer composition to obtain a compact compound structure.

The compound structure may be opaque or translucent. The light transmittance of the compound structure may be 1% to 100%, 1% to 90%, 1% to 50%, or 5 to 50%, preferably 1% to 30%, more preferably 2 to 20%.

### Lacquer Layer

The lacquer layer is an optional layer on the cover layer. The lacquer may be a conventional material. The thickness of the lacquer layer may preferably be 1 to 30 μm, more preferably 3 to 10 μm. The lacquer layer is applied directly on top of the cover layer as a finish of the sheet and serves to protect artificial leather from chemical agents, physical damage, e.g. scratches or abrasion, and UV radiation. The surface lacquering can further reduce the surface adhesion of the artificial leather. Conventional lacquers used for artificial leather for the interior of vehicles can be employed. For example, solvent-based or water-based polyurethanes that are crosslinked with isocyanates or have properties for UV curing are suitable. The surface coating to protect the surface usually consists of one or more, preferably up to four, transparent layers of lacquer. Alternatively, the surface coating may be coloured by adding colour pigments.

The lacquer layer may be an opaque layer or a translucent layer. Preferably, the lacquer layer is translucent and does not affect the translucency of the other layers of the sheet.

### Manufacturing Method

The sheet according to the present invention may be prepared by a method comprising the following steps:
(a) providing a cover layer composition containing at least thermoplastic elastomer;
(b) at least partly melting the thermoplastic elastomer of the cover layer composition;
(c) forming a laminate of the cover layer composition containing the at least partly molten thermoplastic elastomer and a support layer containing a textile layer such that the cover layer composition and the textile layer at least partly interpenetrate each other; and
(d) cooling the cover layer composition to obtain the sheet.

The preparation method may start from a cover layer composition consisting of the thermoplastic elastomer and the other components of the final cover layer.

In step (a), the cover layer composition may be provided in the form of (i) particles such as granules of a cover layer composition or (ii) a finished film containing the cover layer composition.

In the case of (i), step (b) comprises melting the particles of the cover layer composition, preferably using an extruder. In the case of (ii), step (b) comprises heating the film at least on one side to at least partly melt the cover layer composition contained in the film. The cover layer composition may be selected to have a melting temperature that is lower than the melting temperature of the textile layer of the support layer. Thus, the molten cover layer composition penetrates the hollow spaces of the support layer without melting the fibers of the support layer. In that case, the cover layer and the support layer can be separated from each other by heating. Alternatively, the cover layer composition may be selected to have a melting temperature that is equal to or higher than the melting temperature of the support layer and that stands the temperature of the molten cover layer when in contact with it. Thus, the molten cover layer composition at least partly melts the fibers of the support layer when penetrating the hollow spaces. In that case, the cover layer and the support layer are more strongly bonded to each other.

In step (c), the laminate forming is carried out preferably using an extruder in the case of (i). The molten cover layer composition may be extruded and applied onto the support layer, or the molten cover layer composition may be extruded onto a carrier and the support layer may be applied onto the cover layer composition. In both cases, the cover layer composition, the support layer, and the process conditions have to be selected such that the cover layer and the support layer interpenetrate each other to a desired extent. If pressure is applied in forming the laminate, the support layer is compressed thus enabling an easier and deeper penetration by the molten cover layer composition. As a result, the adhesion between the support layer and the cover layer may be stronger.

In the case of (ii), step (c) comprises step (c1) of forming a laminate of the film and the support layer and step (c2) of forming a grained structure by embossing the other side of the film, wherein steps (c1) and (c2) are carried out simultaneously. Step (c) may be carried out using two cylinders. The laminate may be formed by pressing the partly molten side of the film to the support layer while being conveyer through the narrow gap between the two cylinders. The use of the cylinders having a defined gap width enables the preparation of a sheet having a defined thickness of the compound structure. The cylinder contacting the cover layer may have a grained structure which is embossed into the surface of cover layer.

Thus, forming the laminate and embossing may be carried out in a single step.

### EXAMPLES

The following parameters are used to describe the properties of the sheet structure of the present invention:

Weight per unit area: DIN EN ISO 2286-2; Thickness: DIN EN ISO 2286-3 (Surface area 7 cm²; diameter 30 mm; weight 3 N; pressure 0.42 N/cm²; the layer thicknesses are determined microscopically); Tear propagation force: DIN EN ISO 4674-1; Separation force: DIN EN ISO 2411.

Table 1 shows the results of the Examples (Ex. 1 to Ex. 3) and a Comparative Example (C. Ex. 1).

TABLE 1

| | | C. Ex. 1 | Ex. 1 | Ex. 2 | Ex. 3 |
|---|---|---|---|---|---|
| Cover layer | Thickness [mm] | 0.52 | 0.18 | 0.27 | 0.24 |
| Adhesive | | — | | | |
| Textile | Weight per unit | 100 | 100 | 112 | 114 |
| layer | area [g/m²] | | | | |
| Adhesive | | — | | | |
| Sheet | Thickness [mm] | 1.12 | 0.85 | 0.83 | 0.89 |
| | Weight per unit | 616 | 648 | 656 | 647 |
| | area [g/m²] | | | | |
| | Extent of | 0 | 22 | 29 | 37 |
| | interpenetration [%] | | | | |
| | Separation force cover | 27/29 | 36/33 | 76/65 | 68/63 |
| | layer/textile layer [N]; | | | | |
| | longitudinal/transverse | | | | |
| | Tear propagation | 59/54 | 27/37 | 32/35 | 34/38 |
| | force [N]; | | | | |
| | longitudinal/transverse | | | | |
| | Cut & sew properties | | + | + | + |

“+” means that the sample shows the property to a sufficient extent for the intended use.

Criteria for cut & sew properties were foldability and wrinkling of the sample.

The samples meet the requirements of separation force of at least 20 N (longitudinal) and at least 25 N (transverse).

The samples meet the requirements of tear propagation force of at most 15 N (longitudinal and transverse).

What is claimed is:

1. A sheet comprising a support layer, a cover layer and a compound structure, wherein the sheet is suitable for preparing a sewn product by folding the sheet, placing the support layers together and sewing the two parts of the sheet in the contact area, wherein
the support layer contains a textile layer,
the cover layer is a compact layer containing a thermoplastic elastomer, is opaque or has a light transmittance of 1% to 50%, and is arranged on the textile layer of the support layer,
the compound structure consists of a part of the support layer and a part of the cover layer interpenetrating each other, wherein the extent of interpenetration, defined as [(thickness of the compound structure)/(thickness of the cover layer)]×100%, is 5% to 99%, the thickness of the cover layer being the thickness of the compound structure plus the thickness of the part of the cover layer not being part of the compound structure, and
wherein the part of the cover layer not being part of the compound structure has a thickness of at least 0.04 mm.

2. The sheet according to claim 1, wherein the cover layer or a lacquer layer coated on the cover layer is the uppermost layer of the sheet.

3. The sheet according to claim 2, wherein the cover layer is grained on its top side surface and is covered with a lacquer layer as a finish.

4. The sheet according to claim 1,
wherein the extent of interpenetration is 15% to 60%.

5. The sheet according to claim 1,
wherein the support layer contains a textile layer having a thickness of 0.3 to 5.0 mm; the cover layer has a thickness of 0.1 mm to 1.5 mm; and the compound structure has a thickness of 0.01 to 1.0 mm.

6. The sheet according to claim 1,
wherein the support layer comprises a textile layer having a thickness of 0.3 to 5.0 mm, a foam layer having a thickness of 0.5 to 10 mm and, optionally, a textile layer having a thickness of 0.3 to 2.5 mm in this order; or wherein the support layer comprises two textile layers bonded to each other by an adhesive layer.

7. The sheet according to claim 1,
wherein the sheet is obtainable by a process comprising thermally or thermo-mechanically bonding the cover layer and the support layer.

8. The sheet according to claim 1,
wherein the sheet has a tear propagation force according to DIN EN ISO 4674-1 of 10 to 50 N in longitudinal direction and in transverse direction.

9. The sheet according to claim 1,
wherein the sheet is an artificial leather.

10. A sewn product obtainable by sewing the sheet according to claim 1.

11. The sewn product according to claim 10, obtainable by folding the sheet, placing the support layers together and sewing the two parts of the sheet in the contact area.

12. The use of a sheet as described in claim 1 as a surface material in the interior of a vehicle.

13. A method of preparing a sheet as described in claim 1, comprising the following steps:
(a) providing a cover layer composition containing a thermoplastic elastomer;
(b) at least partly melting the thermoplastic elastomer of the cover layer composition;
(c) forming a laminate of the cover layer composition containing the at least partly molten thermoplastic elastomer and a support layer containing a textile layer such that the cover layer composition and the textile layer of support layer at least partly interpenetrate each other; and
(d) cooling the cover layer composition to obtain the sheet.

14. The method of claim 13, wherein the melting in step (b) and the laminate forming in step (c) is carried out using an extruder.

15. The method of claim 13, wherein step (a) comprises providing the cover layer composition in the form of a film made of the cover layer composition, step (b) comprises heating the film at least on one side to at least partly melt the thermoplastic elastomer, and step (c) comprises step (c1) of forming a laminate by contacting the one side of the film and the support layer and step (c2) of forming a grained structure by embossing the other side of the film, wherein steps (c1) and (c2) are carried out simultaneously.

16. The use of a sewn product as described in claim 10 as a surface material in the interior of a vehicle.
